(19) United States
(12) Patent Application Publication
(10) Pub. No.: US 2014/0256218 A1
(43) Pub. Date: Sep. 11, 2014

(54) KAZOO DEVICES PRODUCING A PLEASING MUSICAL SOUND

(71) Applicant: Spyridon Kasdas, Athens (GR)

(72) Inventor: Spyridon Kasdas, Athens (GR)

(21) Appl. No.: 13/792,256

(22) Filed: Mar. 11, 2013

(51) Int. Cl. A63H 5/00; G10D 17/00

(52) U.S. Cl. CPC A63H 5/00; G10D 17/00
USPC 446/416

(57) ABSTRACT

Kazoo devices according to a new kazoo concept, having novel composite vibrating diaphragms configured to vibrate at regular vibrating modes, including electronic audio processing and mixing of the processed audio signal, with a background audio signal.

A method of transforming a person's humming to a pleasing musical sound, including converting the humming sound of a person to audio signal, electronically processing the audio signal, the processed signal serving as an input to other audio devices, or being directly converted to a pleasing kazoo instrumental sound, acoustically perceived as a sound of a saxophone, the processed signal being optionally mixed with a background audio signal.

Several embodiments are illustrated as examples of kazoo devices and kazoo musical instruments, according to this concept and method.

### CROSS-REFERENCE TO RELATED APPLICATIONS

This application claims the benefit of Provisional Patent Application No. 61/618,803, filed Apr. 1, 2012 by Spyridon Kasdas, which is incorporated by reference.

### FEDERALLY SPONSORED RESEARCH

Not Applicable

### SEQUENCE LISTING OR PROGRAM

Not Applicable

### TECHNICAL FIELD

This invention relates generally to musical toys and instruments and relates more particularly to improvements in musical instruments.

### RELATED ART DOCUMENTS

### U.S. Patent Documents

| | | | |
|---|---|---|---|
| 270543 | January 1883 | Frost | Toy or musical instrument |
| 301711 | July 1884 | Frost | Toy musical instrument |
| 552612 | January 1896 | Frost | Resonant musical |
| | | | instrument or toy |
| 591476 | October 1897 | Irving | Musical toy |
| 637261 | November 1899 | Irving | Multiphone |
| 655109 | July 1900 | Pitt | Toy musical instrument |
| 663654 | December 1900 | Crakow | Toy musical instrument |
| 700986 | May 1902 | Smith | Musical toy |
| 705398 | July 1902 | Gustine | Toy horn |
| 1,014,961 | January 1912 | Fawkes | Advertising novelty |
| 1,118,223 | November 1914 | Parmeter | Sounding toy |
| 1,259,600 | March 1918 | Carlisle | Toy musical instrument |
| 52471 | September 1918 | Cohn | Design - Musical Toy or |
| | | | Kazoo |
| 53470 | June 1919 | Sorg | Musical instrument |
| 1,354,959 | October 1920 | Debs | Musical toy |
| 56114 | August 1920 | Aronson | Design - Kazoo |
| 1,465,675 | August 1923 | McIntyre | Musical toy or instrument |
| 1,502,835 | July 1924 | McIntyre | Musical toy |
| 1,576,903 | March 1926 | Fontanella | Musical toy |
| 1,751,491 | March 1930 | Myers | Musical toy |
| 1,759,953 | May 1930 | Myers | Confection musical toy |
| 2,006,732 | July 1935 | Cohn | Kazoo |
| 101969 | November 1936 | Peebles | Humming musical |
| | | | instrument |
| 2,396,250 | March 1945 | dayman | Musical toy |
| 154756 | August 1949 | Ferrier | Kazoo |
| 2,700,316 | January 1955 | Grodon et al. | Toy |
| 154756 | August 1949 | Ferrier | Kazoo |
| 3,256,636 | June 1966 | Green | Toy musical instrument |
| 3,343,298 | September 1967 | Green | Toy voice modifier |
| 3,484,799 | December 1969 | Sioles et al. | Voice amplifier toy |
| 3,883,982 | May 1975 | McClary | Kazoo and Face Mask |
| 269195 | May 1983 | Philip | Design - Simulative toy |
| | | | kazoo |
| 4,832,653 | May 1989 | Berghash | Toy musical instrument |
| 6,491,564 | December 2002 | Miller | Voice amplifier toy |
| D473598 | April 2003 | Izen | Design - Wooden kazoo |
| 6,737,572 | May 2004 | Jameson | Voice controlled electronic |
| | | | musical instrument. |

### Publications

“Drum tuning: an experimental analysis of membrane modes under non-uniform tension”-paper presented by Randy Worland of the Tacoma University of Puget Sound, at the 156th Meeting of the Acoustical Society of America in November 2008.
“Analysis of Drumbeats—Interaction between Drummer, Drumstick and Instrument” by Andreas Wagner—Master's Thesis at the Department of Speech, Music and Hearing (TMH), September 2005-March 2006

### BACKGROUND

### Prior Art

The term kazoo refers to devices including a diaphragm that vibrates sympathetically in response to sound waves produced from a person's humming. The vibrating diaphragm produces a sound having the same pitch, as the person's humming, but a different timbre due to a richer frequency spectrum. The kazoo's sound includes a characteristic buzzing content and is acoustically perceived as a harsh wind instrument's sound.

Derived from ancient African instruments, kazoos have been manufactured and patented for more than a century. While numerous improvements have been patented, claiming changes in the kazoos' shape, appearance and type of materials used, their basic functional structure has not changed and their sound has remained harsh.

Harsh sound is a common characteristic of all prior art kazoos, whether their vibrating diaphragm consists of: a thin stiff membrane vibrating between a rigid perforated diaphragm and a loose body, as described by J. A. Irving in U.S. Pat. No. 591,476 October 1897 and in U.S. Pat. No. 637,261 November 1899 or; a paper diaphragm held by a wire screen against a cylindrical mouthpiece as described by F. J. Gustine in U.S. Pat. No. 705,398, July 1902 or; a diaphragm adjacent to a wire mesh as described by M. W. Sanders in U.S. Pat. No. 1,093,806 April 1914 or; a peripherally secured membrane of paper, oiled paper, tissue, silicone plastic, or other, as in most prior art kazoos.

However, kazoos have interesting operating features. They are easy to play by persons capable of humming a melody in tune, with no valves or buttons typical of other instruments. For this reason, while kazoos have been successful as toys, there has been a long lasting need for kazoos producing a pleasing tone, controlled by the performer.

Attempts, to solve the problem of the kazoo's sound harshness, have been made since the early days of the kazoo's history. In U.S. Pat. No. 655,109 of July 1900, R. Pitt disclosed a kazoo including two oppositely-facing diaphragms, explaining that a single diaphragm is uncertain and irregular in its vibrations, making the tone harsh and unmusical. However, despite the long history of kazoos and the efforts of inventors, the harshness problem has remained unsolved.

Historically, kazoos have been perceived and classified as toys and as musical instruments. As well known in the music art, musical instruments are classified in categories as strings, winds, idiophones and membranophones, all yielding tones by producing periodic vibrations controlled by the performer. Each category is further divisible into groups according to the way the vibrating medium is set into motion. Despite their wind instrument-like sound, kazoos are classified in the category of membranophones, which essentially includes the group of percussion instruments. The properties of the group of percussion instruments, have been scientifically investigated, as shown in publications available on the internet web. An example is the Paper “Drum tuning: an experimental analysis of membrane modes under non-uniform tension” presented by Randy Worland of the Tacoma University of Puget Sound, at the 156th Meeting of the Acoustical Society of America in November 2008. Inversely, the public knowledge on the properties of the group of kazoos, having a membrane excited by sound waves produced from a person's humming, is relatively poor, the kazoos being considered as devices producing vibrations not fully controlled by the performer. Even with the development of audio electronics over the last decades, it has not been attained to smoothen the kazoos' sound by direct electronic processing. For this reason, commercial kazoos have been more successful as toys or advertising specialty items, than as musical instruments.

In the last few years, there has been work done by inventors and instrument manufacturers in the direction of using the humming sound of a person as an input to voice-controlled electronic musical instruments recognising its tone characteristics and producing a synthesized sound having the same characteristics, as described by Jameson in U.S. Pat. No. 6,737,572 May 18, 2004.

In the commercial field, the manufacturer Kazoobie Kazoos has promoted a product called Kazoog, combining a kazoo, a sound transducer and a Guitar-to-MIDI converter, the “G2M” of Sonuss, producing a digital MIDI signal, which can be processed in any MIDI sound module, keyboard, or computer software.

While such developments provide potential advantages, in terms of pitch correction, octave change and multiple choices of instrument sounds, they imply complex digital audio processing for the recognition of tone characteristics such as pitch, loudness and timbre of the kazoo's sound. Audible latency, high manufacturing cost and errors in tone recognition, are known issues of such instruments, particularly for live performance.

### DISCLOSURE OF THE INVENTION

### Problem that the Invention is to Solve

Kazoos yield a harsh sound, including a characteristic buzzing content. Because of their other, above described features, they can provide devices for transforming a person's humming to a pleasing musical sound, if their sound is smoothened and its buzzing content is eliminated. Achieving this result, is a problem that has remained unsolved for more than a century. For better understanding the nature of the problem, the Public knowledge concerning kazoos' operation being poor, it has been necessary to analyse the kazoos' operating conditions, starting from the properties of the sound produced by a person's humming.

Best acoustical results from humming, are obtained when the humming sound arrives to the person's lips directly from the vocal chords, by singing vowels at a comfortable for the person pitch, with an open vocal tract, the tongue being positioned as far as possible from the roof of the mouth, so that there is no build-up of air pressure drop at any point of the vocal tract.

The frequency spectrum of the sound produced by a person humming a specific musical note, includes a fundamental frequency, producing the pitch of the note, roughly in the range of 80 Hz to 1100 Hz, corresponding to musical notes E2 to C6, for normal male and female voices. This spectrum also includes overtones of the fundamental frequency. The fundamental frequency and the overtones up to a frequency of about 2 kHz are usually clearly audible, while higher overtones are weaker and therefore less audible, which explains why the humming sound is not perceived as a rich sound. However, isolated specific overtones in the range 2-8 kHz, may be boosted due to particularities of the person's vocal tract, contributing to a timbre characterizing the humming sound of the specific person.

We will now examine a traditional kazoo's structure. As shown in FIG. 0-PRIOR ART, kazoos include a hollow body 10, having a humming inlet opening 11 serving for a person's humming, an airflow outlet opening 12, of smaller section than the inlet opening 11, discharging the air-flow produced by the person humming and a sound outlet opening 13, obstructed by a detachable, for replacement purposes, vibrating diaphragm 14, secured by a holder 15. The area of the vibrating diaphragm is usually about 100-300 mm², providing for the required loudness of the kazoo's sound. The exact dimensions of a kazoo's components are not critical. In FIG. 0-PRIOR ART the sound-waves introduced into the inlet opening by a person's humming, and the diaphragm sound-waves radiated into the environment, are illustrated by homocentric arcs of increasing length in the direction of the sound-waves, while the inlet and outlet direction of the airflow accompanying humming, is indicated by white arrows. When a person plays a kazoo by humming into the kazoo's inlet opening, the person's lips being closed around the inlet opening, the vibrating diaphragm, being set into motion by the sound-waves produced from humming, vibrates sympathetically at the fundamental frequency and the overtones included in the frequency spectrum of the humming sound. This sympathetic response of the vibrating diaphragm, is affected by the resonance frequencies of the diaphragm. The diaphragm vibrations are boosted, as humming overtones get closer to a resonance frequency of the diaphragm. As a result, the humming overtones, are reproduced by the diaphragm with varying amplitudes, depending on the proximity of each overtone to a resonance frequency of the vibrating diaphragm. The kazoo's sound is richer than the humming sound, because weak non-audible overtones, included in the humming sound, are boosted when reproduced by the diaphragm and become audible. However, the kazoo's sound is harsh, having a characteristic buzzing content related to specific boosted overtones. The human ear does not recognize separate overtones. It recognizes only a tone at the fundamental pitch, including the buzzing content of the kazoo's sound, the tone being perceived as rich but harsh.

Vibrating diaphragms have a plurality of resonance frequencies. For a better understanding, we will consider a circular diaphragm consisting of an ideal circular membrane fixed at the rim. When excited, the membrane vibrates with a superposition of vibration modes. It vibrates as a whole, this mode being the fundamental vibrating mode, but it also vibrates by regions, defined by a number m of nodal diameters and a number n of nodal circles, each combination of m and n corresponding to a different vibration mode, of order (m, n). The fundamental mode, having only the diaphragm's circumference as nodal circle and no nodal diameter, is of order (0, 1). According to the theory governing the resonance of an ideal circular membrane under tension, the value of this fundamental resonance frequency in Hz (Hertz), is function of the membrane diameter D in m (meters), the membrane area density d in kg/m² and the membrane tension T in N/m (Newton/meter), calculated by the formula f(0,1)=0.76/D*(T/d)̂0.5. Real vibrating diaphragms have lower fundamental resonance frequencies than the calculated values for an ideal membrane, because of the stiffness of a real membrane.

The response of a kazoo's vibrating diaphragm is effective at low membrane tension. At high membrane tension, sympathetic vibration requires high-energy sound-waves, which cannot be provided by a person's humming. Therefore, considering that the membrane tension will be set at the lowest possible value ensuring a flat, wrinkle-free surface, the main parameters determining the calculated fundamental resonance frequency of the diaphragm, according to the above formula, are the area and the area density of the membrane. The fundamental resonance frequency of the diaphragm is higher for lower values of each one of these two parameters.

As an example, a membrane having D=0.02 m, d=0.1 kg/m² and T=1 N/m, has a calculated fundamental frequency of about 250 Hz. The resonance frequencies corresponding to higher vibrating modes, are 1.59, 2.14, 2.30, 2.92, 3.50 etc. times the fundamental resonance frequency.

A key element in understanding the harshness problem of kazoos' sound, is that the sound quality of a music instrument depends on the relative position of its audible vibration frequencies, in relation with the various audio ranges of the audio frequency band. It is known that in the music art, the full audio frequency band is broken-down into distinct audio ranges, each considered to affect a different aspect of an instrument's sound. More particularly, the bass audio range (40-250 Hz) affects the fullness of the sound, the lower mid audio range (250-500 Hz) affects the clarity of the sound, the mid audio range (500 Hz-2 kHz) is responsible for horn-like effects causing listening fatigue, if boosted, the upper mid audio range (2-4 kHz) affects the sound recognition, the presence audio range (4-6 kHz) affects the perception of the listener about the distance of the sound source and the brilliance audio range (above 6 kHz) affects the brightness of the sound.

All prior art kazoos include vibrating diaphragms having fundamental resonance frequencies in the bass audio range, or in the lower mid audio range, up to about 500 Hz. This is a significant structural disadvantage, for the following reasons.

Firstly, the fundamental frequency and overtones of the humming sound, are usually clearly audible in the bass audio and lower mid audio ranges, and therefore they do not require any further boosting when reproduced by the kazoo's vibrating diaphragm. On the contrary, excess amplitude in the mid range causes listening fatigue. Therefore, the presence of resonance frequencies of the vibrating diaphragm in these low audio ranges, is not desirable.

Secondly, at such low fundamental resonance frequencies, diaphragms vibrate at irregular vibrating modes and produce irregular resonance frequencies uncontrolled by the performer, spread over the higher audio ranges. In such conditions, the buzzing content of a kazoo's sound cannot be effectively filtered for obtaining a pleasing sound.

### Means for Solving the Problem

To solve the harshness problem of kazoo's sound, there is need for a new concept of vibrating diaphragms, having fundamental resonance frequencies in the higher quartile of the mid audio range, or in the upper mid audio range, e.g. at about 2,000 Hz. Kazoos having such vibrating diaphragms, will better perform: preventing listening fatigue; providing a rich kazoo's sound, by boosting weak humming overtones in higher audio ranges, and; ensuring vibration at regular vibrating modes, providing for effective identification and filtering of frequencies causing buzzing.

Obtaining such a high fundamental resonance frequency, is not achievable by prior art kazoos. Even using a very thin membrane, having a very low area density, the required vibrating area would be too small to produce audible sound. As an example, assuming a very thin circular membrane, having an area density of d=0.03 kg/m² and a membrane tension of 0.25 N/m, the calculated required membrane diameter for a fundamental resonance frequency of 2,000 Hz, would be about 1 mm. Such a small membrane would be insufficient to produce an audible kazoo sound.

To solve this technical problem, the present invention introduces a new kazoo device concept, having a novel composite vibrating diaphragm including a very thin and pliant film, stretched across the surface of a rigid perforated disk having a plurality of holes distributed across its surface, the film forming an individual vibrating membrane fixed at the rim at each hole of the perforated disk, while the vibrations of the entire film as a whole, are damped by the perforated disk. Such novel vibrating diaphragms have high fundamental resonance frequencies, corresponding to the small area of each individual membrane, while every individual membrane is contributing to the loudness of the produced sound. The desired fundamental resonance frequency is obtained by the combination: of an adequate film area density and; an adequate dimensioning of the holes of the perforated disk.

For a better understanding of this new kazoo concept and its features, illustrations of simple kazoo configurations according to this concept and detailed explanation of their operating conditions, are provided in the detailed description and accompanying drawings, of Embodiments 1, 2 and 3.

Furthermore, the present invention provides a method of transforming a person's humming to a pleasing instrumental musical sound, comprising:
(a) providing a kazoo device including a diaphragm forming a plurality of individual membranes fixed at the rim, vibrating at regular vibrating modes and having predetermined fundamental resonance frequencies,
(b) converting the kazoo device's sound to audio signal,
(c) electronically processing the audio signal for adjusting the amplitude of predetermined frequency bands and applying desired audio effects,
(d) mixing the processed the audio signal with another audio signal produced by an integrated or an external audio source, serving as background accompany music,
(e) converting the processed audio signal to sound.

This method provides for a variety of new electronic kazoo devices and kazoo musical instruments yielding a pleasing rich instrumental sound, free from buzzing content, acoustically perceived as a saxophone's, or other wind instrument's sound, depending on the applied audio effects.

Examples of electronic audio devices and musical instruments, according to this method and detailed explanation of their operating conditions, are provided in the detailed description and accompanying drawings, of Embodiments 4, 5 and 6.

Other configurations of kazoo instruments are described in Embodiments 7 and 8, as examples of the variety of devices witch can be made according to this invention.

These and other advantages of one or more aspects will become apparent from a consideration of the ensuing description and drawings.

### SUMMARY

The present invention provides method and apparatus for new kazoo devices and electronic kazoo audio devices and musical instruments, transforming a person's humming sound to a pleasing musical sound.

In accordance with one aspect of the invention, kazoo devices according to a new kazoo device concept, include novel composite vibrating diaphragms configured to vibrate at regular vibrating modes, having fundamental resonance frequencies in the higher quartile of the mid audio range, or in the upper mid audio range, yielding smoothened sound and providing for effective filtering of any buzzing content. The new kazoo device concept provides for a variety of kazoo devices. Examples of such kazoo devices are illustrated in the detailed description and accompanying drawings.

In accordance with another aspect of the invention, a method of transforming a person's humming to a pleasing musical sound, includes converting the sound of kazoo devices according to the new kazoo device concept, to audio signal, electronically processing the audio signal for adjusting the amplitude of predetermined frequency bands and applying desired audio effects, the processed signal serving as an input to other audio devices, or being directly converted to a pleasing kazoo instrumental sound, acoustically perceived as a sound of a saxophone, or other wind instruments, depending on the applied audio effects. The processed signal is optionally mixed with a background audio signal produced by an audio source. This method provides for a variety of electronic kazoo audio devices and electronic kazoo musical instruments. Examples of such devices and musical instruments, are illustrated in the detailed description and accompanying drawings.

These and other inventions are described herein and/or set forth in the claims herein.

### BRIEF DESCRIPTION OF DRAWINGS

For purpose of explanation, examples of embodiments according to the principles of the present invention are illustrated in the following figures. A three digit reference numbering is being used for the details of the drawings, the first digit corresponding to the discussed embodiment and the other two digits providing the same reference numbers for similar components in different embodiments.

A figure, labelled FIG. 0-PRIOR ART, preceding the figures illustrating the embodiments according to present invention, is a perspective view of a prior art a kazoo, using a two-digit reference numbering.

FIG. 1 is a perspective exploded side view of a kazoo device including a novel composite diaphragm, in its simplest configuration, according to Embodiment 1.

FIG. 2 is a side cross-sectional view of the kazoo device of FIG. 1, by the section lines 2-2 in FIG. 1, illustrating its operating conditions.

FIG. 3 graphically illustrates the effect of the new composite diaphragm on the kazoo device's sound frequency spectrum. The group of curves A represents the frequency spectrum of the sound produced by a person humming a series of musical notes of increasing frequency. The group of curves B represents the response of a kazoo device including a novel composite vibrating diaphragm, while the group of curves C represents the kazoo device's response after removal of the perforated disk of the composite diaphragm.

FIG. 4 is a perspective side view of a mouth-held kazoo device, according to Embodiment 2.

FIG. 5 is an exploded side cross-sectional view of the kazoo device of FIG. 4 by the section lines 5-5 in FIG. 4.

FIG. 6 is an exploded perspective side view of the novel vibrating diaphragm 214 in FIG. 5.

FIG. 7 is a perspective side view of the kazoo device of FIG. 4, further including a Helmholtz resonator, according to Embodiment 3.

FIG. 8 is a side cross-sectional view of the kazoo device of FIG. 7 by the section lines 8-8 in FIG. 7.

FIG. 9 is a graphic representation of the frequency spectrum of the sound of the kazoo device of FIG. 7, illustrating the filtering effect of the Helmholtz resonator.

FIG. 10 is a perspective side view of a kazoo device transforming a person's humming to a processed audio signal serving as input to other audio devices, according to Embodiment 4.

FIG. 11 is an exploded side cross-sectional view of the audio device of FIG. 10, by the section lines 11-11 in FIG. 10.

FIG. 12 is an exploded side cross-sectional view of the microphone enclosure 420 in FIG. 11, by the section lines 12-12 in FIG. 11.

FIG. 13 is a side cross-sectional view of the audio device of FIG. 10, by the section lines 11-11 in FIG. 10, illustrating a replacement of battery 436 in FIG. 13.

FIG. 14 is a block diagram illustrating the steps of electronic processing of the audio signal provided by the electronic circuit 433 in FIG. 13.

FIG. 15 is a detailed schematic representation of the electronic circuit 433 in FIG. 13.

FIG. 16 is a perspective side view of a self-contained kazoo musical instrument transforming a person's humming to a pleasing instrumental sound, according to Embodiment 5.

FIGS. 17 and 18 are the two parts of a hands-free kazoo musical instrument transforming a person's humming to a pleasing instrumental sound, according to Embodiment 6, FIG. 17 being a side view of the kazoo device of FIG. 2, further including a sound transducer and FIG. 18 being a perspective front view of an electronic device, the two parts being connected via an audio cable.

FIG. 19 is a side cross-sectional view of the kazoo device of FIG. 17, by the section lines 19-19 in FIG. 17.

FIG. 20 is a side cross-sectional view of the electronic device of FIG. 18, by the section lines 20-20 in FIG. 18.

FIG. 21 is a side cross-sectional view of the electronic device of FIG. 20, by the section lines 21-21 in FIG. 20.

FIG. 22 is a perspective side view of another example of kazoo device configuration according to Embodiment 7.

FIG. 23 is a perspective side view of another example of configuration of a kazoo device including a Helmholtz resonator according to Embodiment 8.

FIG. 24A is a side cross-sectional view of the kazoo device of FIG. 23 by the section lines 24A-24A in FIG. 23.

FIG. 24B is a front cross-sectional view of the kazoo device of FIG. 24A, by the section lines 24B-24B in FIG. 24A.

FIG. 25 is an exploded view of the novel composite diaphragm included in the kazoo device of FIG. 24A.

### DETAILED DESCRIPTION OF THE INVENTION

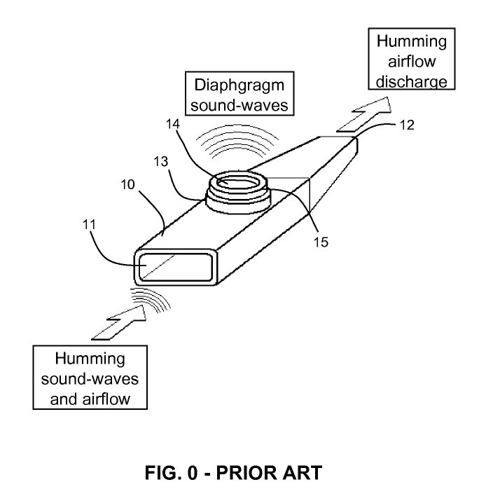

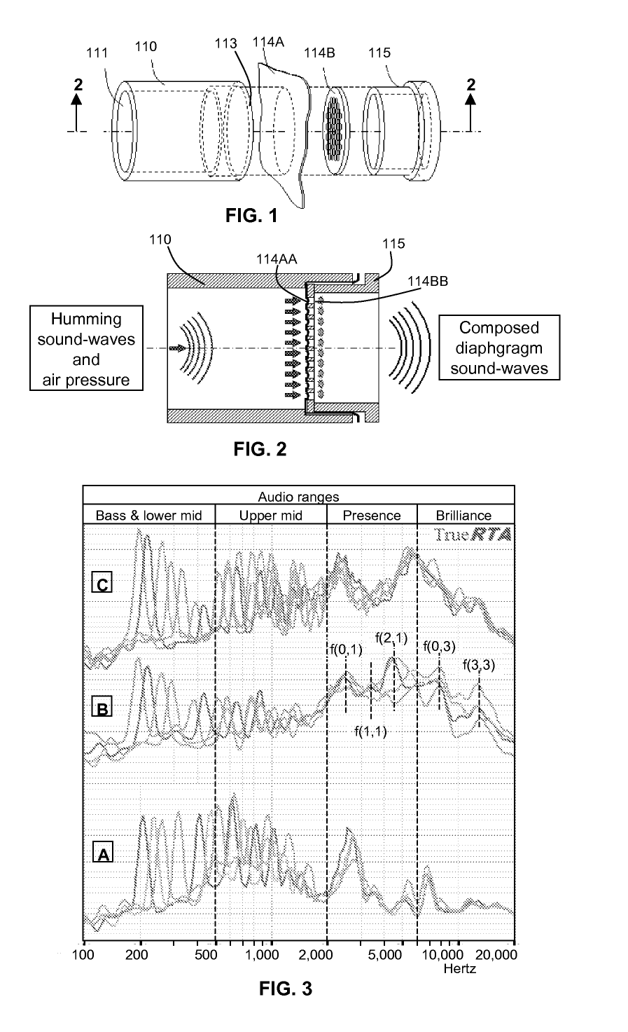

### FIG. 1—Embodiment 1

FIG. 1 illustrates a kazoo device according to Embodiment 1. In this simple configuration, the kazoo device comprises: a hollow body 110, which in this case is a cylindrical tube of hard plastic, having an inlet opening 111 serving for a person's humming and a sound outlet opening 113; a composite vibrating diaphragm including a rigid circular perforated disk 114B, having a plurality of holes distributed across its surface and a thin plastic film stretched across the surface of the disk and peripherally fixed to the disk, the film obstructing the sound outlet opening 113; a holding means, in this case a tube 115 of soft plastic, holding the diaphragm attached to the sound outlet opening 113.

Referring to the mounting details of this kazoo device, the sound outlet opening 113 in FIG. 1, has an enlarged internal section, fitting loosely the external section of the circular perforated disk 114B, made of hard plastic and fitting tightly the external section of the holder 115, made of soft plastic. The film 114A, very thin and pliant, having an initial area larger than the section of the sound outlet opening, is inserted between the sound outlet opening and the perforated disk. During mounting, the film and the perforated disk are inserted into the sound outlet opening 113 and are clamped peripherally between the narrower internal section of the kazoo device's body and the holder 115, the film tension being adjusted, by initial stretching, to the minimum uniform tension required to prevent any wrinkle formation on the active surface of the film, defined by its peripherally clamped portion. The portion of the film exceeding the section of the sound outlet opening, is cut and removed.

### FIGS. 2 and 3—Embodiment 1—Operation

FIG. 2 illustrates the operating conditions of the kazoo device concept. The active surface of the film, defined by its peripherally clamped portion, is directly exposed to the air pressure and to the sound-waves developed in the kazoo device's body by a person's humming. There is no airflow through the kazoo device's body, only air pressure is developed.

In FIG. 2, the air pressure is illustrated by black arrows and the sound-waves are illustrated by homocentric arcs of increasing length in the direction of radiation of the sound-waves. This air pressure in the kazoo device's body being higher than the external atmospheric pressure, the film is pressed against the perforated disk. As a result, the vibrations of the film as a whole are damped by the perforated disk, while each portion of the film 114AA, facing a hole of the perforated disk 114BB, behaves as an individual vibrating membrane fixed at the rim, being excited by the sound-waves produced from humming. The film vibrations at each hole, produce sound-waves, which are radiated in the environment through the holes, composing the kazoo device's sound.

This is a new feature, distinguishing substantially the kazoo device concept over prior art. Considering an example of a prior art kazoo including a diaphragm having a vibrating area of 200 mm², the fundamental resonance frequency corresponds to the vibration of this entire area. An example of kazoo device including a composite diaphragm having the same total film area of 200 mm² and a perforated disk having 60 holes, each hole having an area of 1 mm², will have a total vibrating area of 60 mm², providing lower but sufficient loudness of the kazoo device's sound, while having a significantly higher fundamental resonance frequency, corresponding to the significantly smaller area of each hole. As explained in the following paragraphs, this is a major development in terms of yielding a smoothened and controlled kazoo device's sound.

It is understood that the shape, appearance and dimensions of a kazoo device and its components, according to this novel concept, are not critical. The determining condition is the capacity of forming individual vibrating membranes at the holes of the perforated disk, capable of being excited by a person's humming. These conditions are analysed in the following paragraphs.

When the humming sound arrives directly from the person's vocal chords, with an open vocal tract, the air pressure, developed in the kazoo device's body, exceeds the external atmospheric air pressure by about 100 Pascal. The precise air pressure value depends on the person's humming technique. By practicing, a person learns quickly how to control this pressure, having the lips more or less tightly pressed against the kazoo device's inlet opening, for obtaining an optimised kazoo device's sound.

The air pressure differential at the two sides of the composite vibrating diaphragm being given, the determining condition for forming individual vibrating membranes, is obtained with a film sufficiently thin, pliant and flat when slightly stretched, for a given perforated disk having holes of predetermined section. The number of holes is determined in relation to the desired loudness of the kazoo device's sound. The lowest possible initial film tension preventing wrinkle formation is required for forming individual vibrating membranes by effortless humming.

The film area density and the section of the holes of the perforate disk are parameters that affect the value of the resonance frequency at the fundamental vibrating mode. This value defines the relative position of the resonance frequencies of higher vibrating modes, in relation with the various musical audio ranges, affecting the timbre of the kazoo device's sound.

This novel composite vibrating diaphragm provides for a fundamental resonance frequency in the higher quartile of the mid audio range, or the upper mid audio range and for regular vibrating modes. For a better understanding of this important feature, we will analyse the behaviour of the specific example of the kazoo device of Embodiment 1, firstly according to the theory of vibrating membranes and secondly according to the obtained experimental results.

In the configuration of Embodiment 1, the kazoo device includes a composite diaphragm having a polyethylene film 1.25 mil (thickness 1.25/1000 inch), as films widely used for small domestic food freezer bags, with an area density of d=0.03 kg/m² and a circular total active surface having a diameter of 0.018 m, combined with a perforated disk having circular holes of equal diameter of D=0.001 m, evenly distributed across its surface and representing about 30% of this surface. Assuming an air pressure differential applied on the film of P=100 Pascal and a cross section radius of each individual vibrating membrane of R=5D=0.005 m, the film tension, according to LaPlace's law, is calculated by the formula T=PR/2=0.25 N/m.

The fundamental resonance frequency f (0,1) of each individual vibrating membrane formed at each hole, is about 2.2 kHz, as calculated according to the formula f (0,1)=0.76/D*(T/d)̂0.5, provided by the theory governing the resonance of an ideal circular membrane under tension. The resonance frequencies corresponding to higher vibrating modes, are spread over a frequency band starting at 2.2×1.59=3.5 kHz.

For comparison purposes, a diaphragm including the same film but no perforated disk, under the same assumptions, has a calculated fundamental resonance frequency of about 0.5 kHz and resonance frequencies corresponding to higher vibrating modes, spread over a frequency band starting at 0.8 kHz.

The real resonance frequencies of a vibrating diaphragm are usually lower than the calculated values for an ideal membrane, because of the film stiffness. They can also deviate from the calculated values, depending on the real value of the film tension. However, the calculated values reflect the order of magnitude of the real values, as demonstrated by the experimental results shown in FIG. 3.

In FIG. 3, the group of curves A, graphically represents the measured frequency spectrum of a series of progressively higher musical notes, produced by a male person's humming. The group of curves B represents the response of the kazoo device of Embodiment 1, to the same series of progressively higher musical notes produced by a male person's humming, while the group of curves C, represents the response of the kazoo device after removal of the perforated disk from the composite diaphragm, the film being free to vibrate as a whole. This investigating technique applied, of plotting a series of progressively higher musical notes, facilitates the visual identification of the diaphragm's resonance frequencies on the graphic representation of the frequency spectrum, these resonance frequencies of a given diaphragm configuration, being unaffected by the changes of musical notes, taken into account that small variations of resonance frequencies may occur due to membrane tension variations affected by changes of the air pressure produced from humming different musical notes.

The examination of the group of curves A in FIG. 3, shows that the overtones of the humming sound have a decreasing amplitude as their frequency increases in the audio range up to about 2 kHz. Additionally, the group of curves A shows frequency amplitude peaks at specific frequencies, the main peaks being observed at about 2.6 kHz and 6.0 kHz, related to particularities of the person's vocal tract.

The group of curves B, reflects a controlled vibrating behaviour of the composite diaphragm. The bass, the lower mid and the upper audio ranges, up to about to 2 kHz, are unaffected by resonance frequencies. The effect of resonance frequencies is clear in the presence and brilliance audio ranges, between about 2 and 12 kHz. In rounded figures, the pattern of peaks reveals a fundamental resonance frequency of about f(0,1)=2.1 kHz and corresponding resonance frequencies at higher vibrating modes of: f(1,1)=1.59f(0,1)=3.3 kHz, f(2,1)=2.14f(0,1)=4.5 kHz, f(0,3)=3.60f(0,1)=7.6 kHz and f(3,3)=5.4f(0,1)=11.5 kHz.

Inversely, the group of curves C reflects an uncontrolled vibrating behaviour of the film, related to the removal of the perforated disk, corresponding to the operating conditions of prior art kazoos. The high amplitude of frequencies in the mid audio range (500-2,000 Hz), is an indication of a fundamental resonance frequency in the proximity of 0.5 kHz, while the large number of peaks in the presence audio range, corresponding to resonance frequencies with non obvious vibrating pattern, is an indication of irregular vibrating modes.

The spectrum profile of the composite diaphragm, illustrated by the group of curves B, provides for removing any buzzing content, by identifying through testing and filtering specific frequency bands causing buzzing. This spectrum profile also provides for adjusting, as desired, the tone of the kazoo device's sound by electronically boosting or attenuating specific frequency bands in the above audio ranges.

These features distinguish substantially the kazoo device concept over prior art.

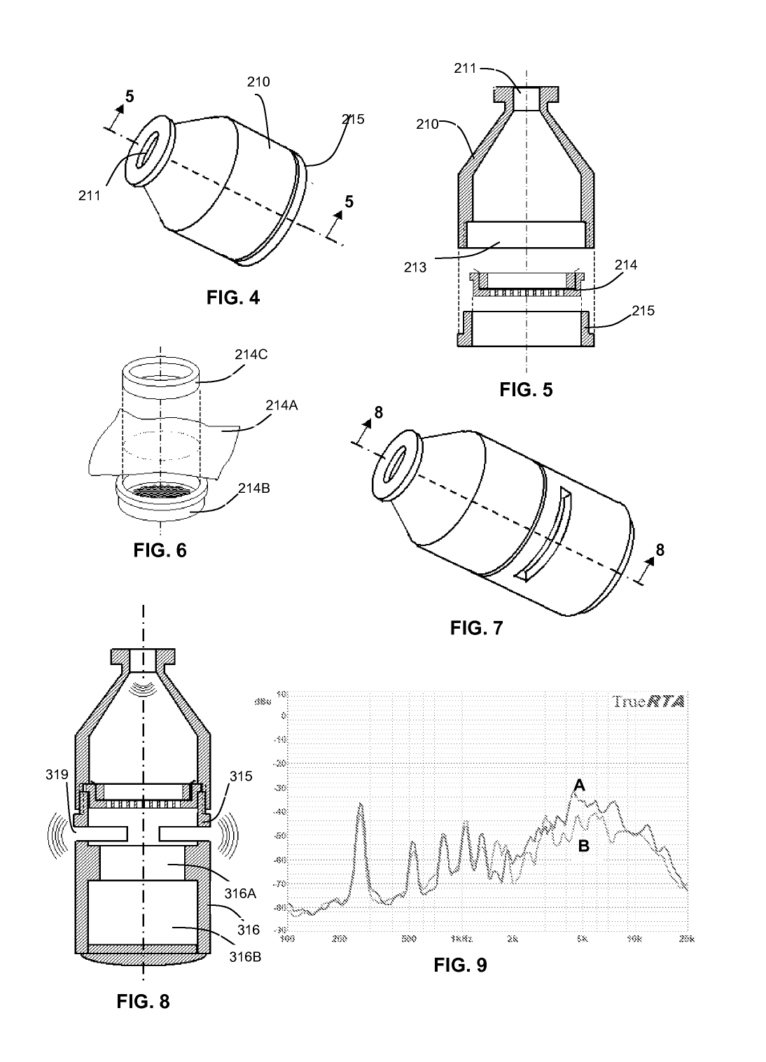

### FIGS. 4, 5 and 6—Embodiment 2

Embodiment 2 is another example of configuration of a kazoo device according to the kazoo device concept, having an additional feature of being mouth-held. This feature provides for hands-free operation, the hands of the person playing the kazoo device being available for accompanying the hummed melody, by playing another hand operated instrument. The mouth-held kazoo device also provides for being played by disabled persons. FIG. 4 illustrates a perspective view of a kazoo device according to Embodiment 2. As shown in more detail in FIG. 5 the kazoo device comprises: a hollow body 210 having an inlet opening 211 and a sound outlet opening 213; a vibrating diaphragm 214 obstructing the sound outlet opening 213 and a holder 215 configured to secure the diaphragm 214 in its location.

In this configuration, the hollow body 210 has a conical part of which the narrower end is forming the inlet opening 211 and the larger end is having a cylindrical extension with an open end forming the sound outlet opening 213. The inlet opening 211 has a flanged extension providing for the kazoo device being held by the player's front teeth, while the player's lips are closed around the conical part.

The sound outlet opening 213 is internally enlarged and threaded, fitting the holder 215, which in this case is a flanged cylindrical ring, externally threaded. The vibrating diaphragm 214 is clamped between the sound outlet opening 213 and the holder 215.

The vibrating diaphragm 214, as shown in detail in FIG. 6, includes a very thin, pliant film 214A, in this configuration made of polyethylene 1.25 mil (1.25/1000 inch), a circular perforated disk 214B of rigid plastic and a locking ring 214C of soft plastic.

The perforated disk 214B forms the bottom of a flanged cylindrical recipient having an internal diameter fitting tightly the external diameter of the locking ring 214C. The film 214A, having a larger initial area than the ring 214C, is inserted between the flanged recipient and the ring 214C.

During mounting, the ring 214C is pressed into the recipient, the film being uniformly slightly stretched, providing for a wrinkle free film surface, the film being peripherally clamped between the perforated disk 214B and the ring 214C. The remaining film portion outside the recipient, is cut and removed. The perforated disk has a plurality of holes spread across the surface, in this case circular holes all having a diameter of 1 mm, the total area of the holes representing about 30% of the disk's surface.

### FIGS. 7, 8 and 9—Embodiment 3

Embodiment 3, illustrated in FIGS. 7 and 8, is an example of a kazoo device according to Embodiment 2, further including a mechanical band-stop filter based on the principle of a Helmholtz resonator 316 in FIG. 8, having a port 316A facing the kazoo device's vibrating diaphragm and a cavity 316B. As shown in FIG. 8, the Helmholtz resonator 316 and the holder 315 form one body, having side openings 319 between the holder 315 and the Helmholtz resonator 316, providing for radiating the kazoo device's sound-waves into the environment.

The Helmholtz resonator is configured to attenuate a frequency band including frequencies causing buzzing and sound harshness, providing for a pleasing kazoo device's sound. The fundamental resonance frequency of a Helmholtz resonator is given by the formula: fo=0.5*c/e(S/L/V)̂0.5, where fo is the fundamental resonance frequency of the resonator in Hz, c is the speed of sound in the air in m/s, S is the area of the port in m², L is the effective length of the port in m and V is the volume of the cavity in m³. The bandwidth of the band-stop filter, is given by the formula BW=fo/Q, where BW is the bandwidth in Hz and Q is the quality factor of the resonator, given by the formula Q=b*2*e(V*(L/S)̂3)̂0,5, where b is a coefficient having a value between 1 and 2.

In this Embodiment 3, the Helmholtz resonator is configured to attenuate a frequency band centered at about 6 kHz, corresponding to its fundamental resonance frequency. To this purpose, the Helmholtz resonator is dimensioned as follows: S=0.000254 m², L=0.0092 m, V=0.00000266 m³. With c=343 m/s and b=1, we obtain in rounded figures, calculated values of about fo=6 kHz and BW=4 kHz.

FIG. 9 is a graphic representation of the frequency spectrum of the sound of the kazoo device of Embodiment 3 corresponding to a hummed music note A3, the bold curve labelled “A” in FIG. 9 representing the spectrum when the Helmholtz resonator is removed, while the lighter curve labelled “B” represents the spectrum when the Helmholtz resonator is present. This graphic representation confirms the attenuation of the targeted frequency band, providing a pleasing kazoo device's sound of Embodiment 3.

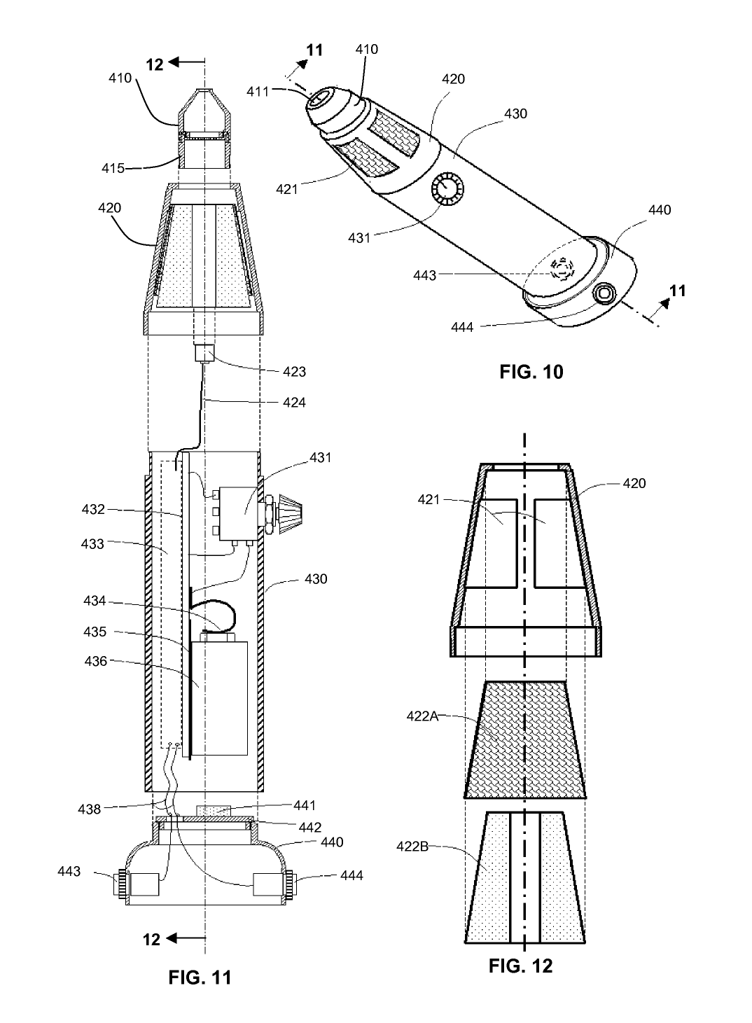

### FIGS. 10, 11, 12 and 13—Embodiment 4

Embodiment 4 is an example of a hand-held electronic kazoo device, according to the disclosed method of transforming a person's humming to a pleasing instrumental musical sound. This kazoo device is the kazoo device of Embodiment 2, further including a sound transducer, in this case a mini condenser microphone capsule, converting the kazoo device's sound to audio signal and an electronic circuit processing the audio signal for adjusting the amplitude of predetermined frequency bands and applying desired audio effects. The output audio signal is serving as input signal to external audio devices. When converted to sound, the output audio signal is acoustically perceived as a sound of a saxophone, or other wind instruments, depending on the applied audio effects.

Embodiment 4, as shown externally in FIG. 10, has a kazoo device 410; a conical microphone enclosure 420 having wide side openings 421; a cylindrical electronics and battery enclosure 430, serving also as grip part and supporting an on/off and volume rotating control knob 431 and; a cylindrical connector enclosure 440 having an audio input stereo socket jack 443, serving for connecting to an external audio device such as an mp3 player, or a rhythm box and an output stereo socket jack 444, serving for connecting earphones, or an external audio device, or an amplified speaker.

The internal components of Embodiment 4 and their inter-connexions, are shown in FIG. 11.

The holder 415, of the kazoo device 410 in FIG. 11, has a tapered extension, of hard plastic, providing for attachment to the microphone enclosure 420.

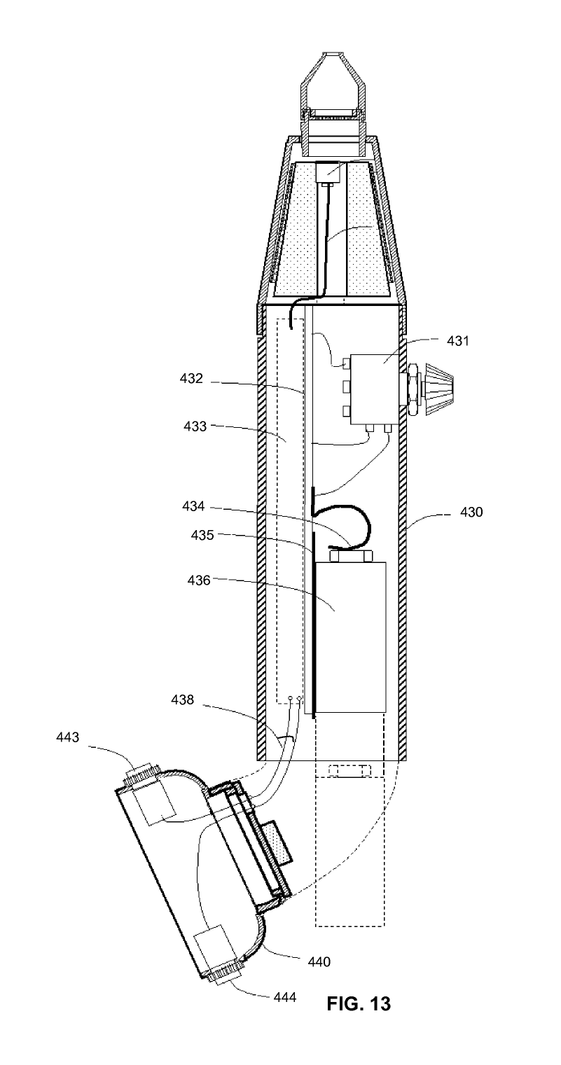

The microphone enclosure 420, of soft plastic, has a conical shape with an opening at its smaller end, fitting tightly the tapered extension 415. The wider end of the microphone enclosure 420, has a cylindrical extension having an internal section fitting tightly the electronics and battery enclosure 430. As shown, in more detail, in the exploded side cross sectional view in FIG. 12, the microphone enclosure has wide side openings 421 and contains a conical metallic protective screen 422A and a tubular conical foam microphone cover 422B.

Referring back to FIG. 11, a mini condenser microphone capsule 423 is connected to a semi-rigid audio cable 424 fixed to an electronic circuit board 432 contained in the electronics and battery enclosure 430. When the microphone enclosure 420 is attached to the electronics and battery enclosure 430, the microphone capsule 423 is inserted in the tubular foam cover 422B, the microphone capsule being located close to the kazoo device's vibrating diaphragm. These arrangements provide for easy detachment for maintenance, or tuning purposes.

The electronics and battery enclosure 430 in FIG. 11, is an open at both ends tubular cylinder of hard plastic. It has a side opening supporting an on/off and volume control knob 431 and contains a circuit board 432 having on its side facing the control knob, an isolating film 435 and a battery connector 434 for a 9 Volt PP3 battery 436 and on its other side the electronic circuit 433, serving for electronic processing of the audio signal produced by the microphone capsule 423. As shown in FIG. 11, the electronics and battery enclosure 430 is capped at one end by the microphone enclosure 420, and at its other end by the connector enclosure 440. FIG. 13, illustrates a battery replacement, the connector enclosure 440 being detached from the electronics and battery enclosure 430.

Referring back to FIG. 11, the connector enclosure 440, of soft plastic, has a first cylindrical part, of larger section, having side openings supporting an audio input socket jack 443 and an output socket jack 444 and a second cylindrical part, of smaller section, fitting tightly the electronics and battery enclosure 430. The end of this second part is closed with a cap 442 having an opening for the cables 438 connecting the jacks to the circuit board. The cap supports a rubber disk 441 serving for holding the battery pressed against the battery connector. The other end of the connector enclosure 440 is closed.

The choices made of soft plastic, or hard plastic, for the described enclosures, provide for easy and effective engagement or disengagement between them, as required.

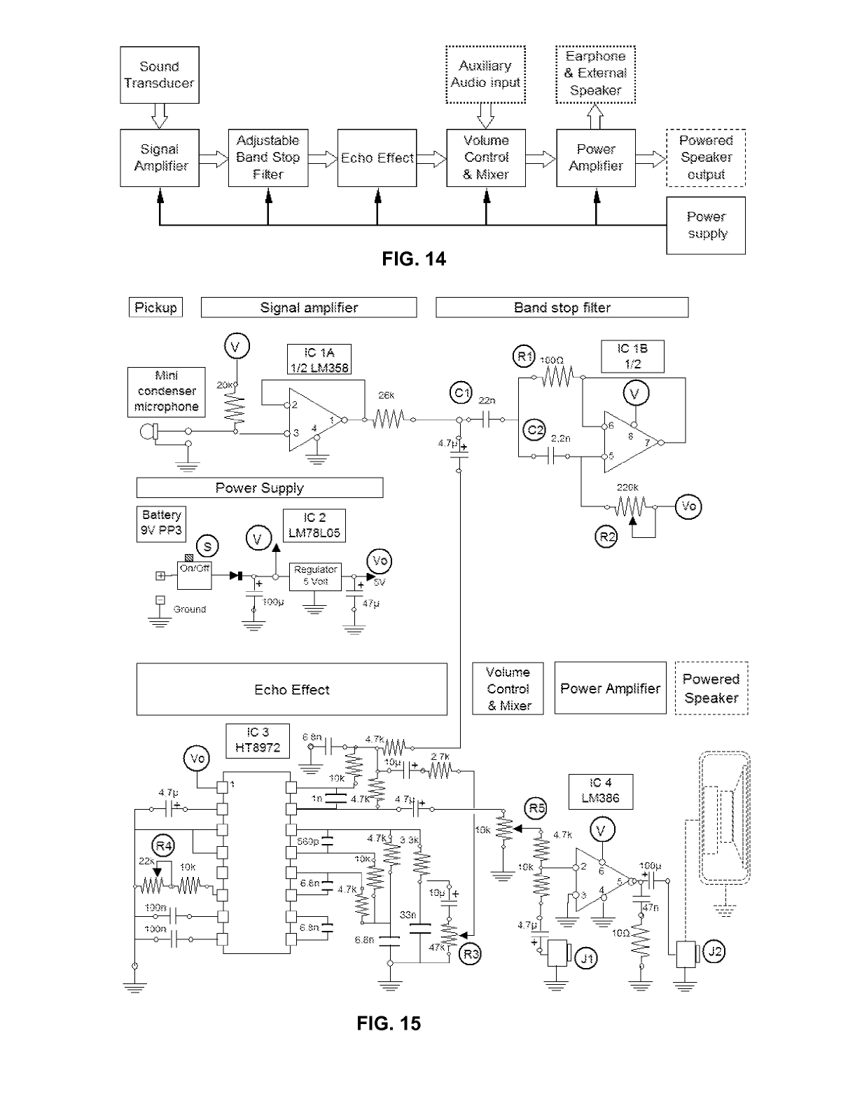

### FIGS. 14 and 15—Embodiment 4—Operation

Referring back to FIG. 11, the sound of the kazoo device 410 is captured by the microphone capsule 423 and is converted to audio signal electronically processed by the electronic circuit 433.

As illustrated in the block diagram of FIG. 14, the electronic processing includes amplification of the microphone audio signal, attenuation of the undesired frequency band causing buzzing via an adjustable band stop filter, application of echo effect, volume control of the filtered signal, mixing with an external audio signal if supplied and power amplification of the output signal for connexion to earphones, or an external amplified speaker, or other audio device.

As shown in more detail in the electronic circuit diagram of FIG. 15, the electronic circuit 433 in FIG. 11, comprises four low cost Integrated Circuits including one voltage regulator, all powered by a V=9 Volt PP3 battery 436 and a minimized number of common passive electronic components.

In more detail IC1, an Integrated Circuit LM358 of Texas Instruments including two operational amplifiers IC1A and IC1B, is used for the amplification of the microphone audio signal and for the adjustable band-stop filter, supported by a regulated Vo=5 Volt reference voltage provided by IC2, an Integrated Circuit LM78L05 of Texas Instruments.

The amplification circuit includes a 20 kOhm resistor connected to the microphone capsule, providing low microphone sensitivity, preventing its saturation due to its closeness to the kazoo device's diaphragm, reducing the noise effect of external sounds and preventing a Larsen effect.

The adjustable band-stop filter provides for effective tuning of its central frequency, by setting the variable resistance R2 at a value acoustically optimising the output sound, being monitored via earphones connected to the output socket jack J2.

IC3, an Integrated Circuit HT8972 of Holtek Semiconductor Inc., is used for applying echo effect, according to the relevant supplier's datasheet. Two variable resistances R4 and R5, provide for tuning respectively two echo parameters, the feedback rate and the delay, by setting each at values acoustically optimising the produced sound.

These tunings being required only initially, at the testing stage following manufacturing, the variable resistances are located within the electronics and battery enclosure, being available only to qualified persons.

IC4, an Integrated Circuit LM386 of National Semiconductor, is used as audio power amplifier supported by passive electronic components described in the relevant supplier's datasheet.

The control knob 431 in FIG. 11 combines the on/off power switch S in FIG. 15 and the control of the variable resistance R5 in FIG. 15. The input socket jack J1 in FIG. 15 operates as a mono jack. If a connected external device provides a two channel stereo audio signal, only one channel is connected to the electronic circuit.

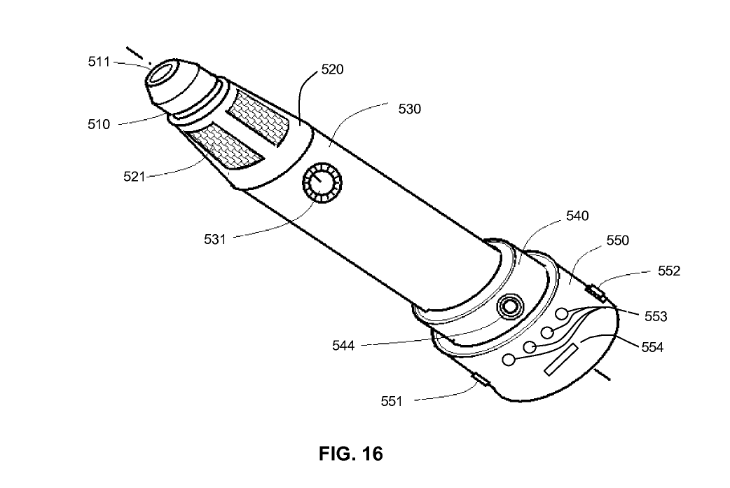

### FIG. 16—Embodiment 5

Embodiment 5, illustrated in FIG. 16, is the electronic kazoo device of Embodiment 4, further including an internal powered speaker, e g. an available in the market speaker as produced in China and commercialized worldwide by KAIDAER including an integrated mp3 player 550, having a USB connector 551 enabling battery recharging and connexion to a PC for background accompany music transfer to an internal memory card, an on/off button 552, control buttons of the mp3 player 553, and a memory card reader 554. When an external amplified speaker, or earphones are connected to the output socket jack 544, the internal powered speaker 550 is automatically disconnected.

Embodiment 5 provides a low cost, portable, compact and self-contained electronic kazoo musical instrument transforming a person's humming sound to a pleasing instrumental sound with background music accompany, capable of being connected to earphones for practice, or to external amplified speakers, or audio consoles for live performance with zero latency, providing for accompanying the played melody with music, or rhythm, from an external audio device.

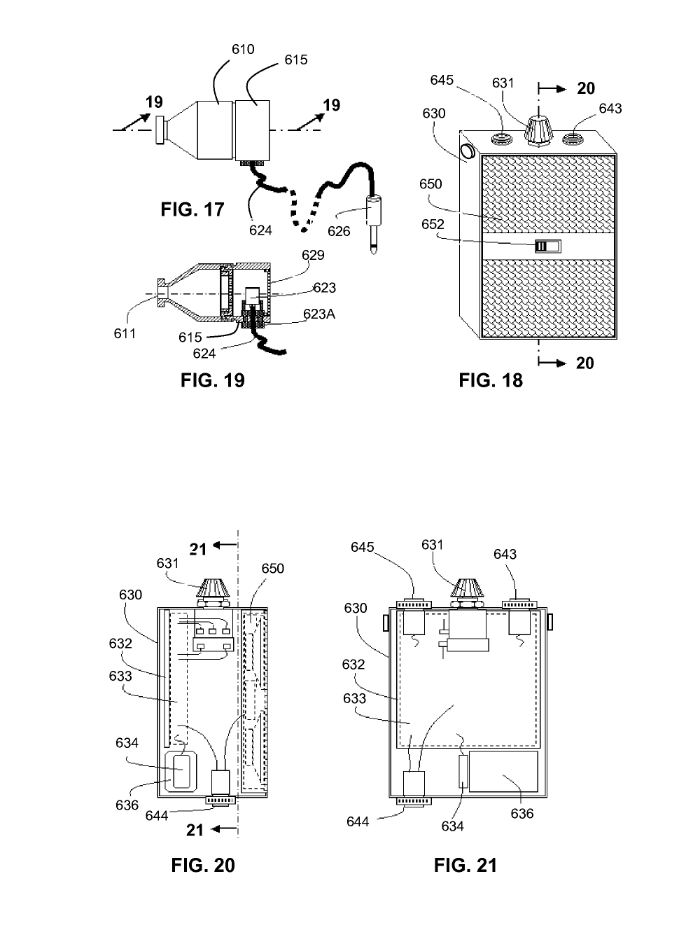

### Detailed Description—FIGS. 17, 18, 19, 20 and 21—Embodiment 6

Embodiment 6, illustrated in FIGS. 17 and 18 is an electronic kazoo instrument having the same functions as Embodiment 5, but being mounted in two separate parts, for a hands-free operation.

The first part of Embodiment 6, illustrated in FIG. 17, is a mouth-held kazoo device 610. As shown in more detail in FIG. 19, the kazoo device 610 includes a mini condenser microphone capsule 623 connected to an audio cable 624. The other end of the audio cable 624 has an audio plug jack 626 in FIG. 17. The holder 615 in FIG. 19 of the kazoo device 610, has a cylindrical extension with a side opening providing for the insertion of the microphone capsule 623 and a rubber seal 623A, holding the audio cable 624, the microphone capsule 623 being held by the cable 624 and the rubber seal 623A. The open end, of the extension of the holder 615, is obstructed by a protective wire screen 629.

The second part of Embodiment 6, illustrated in FIG. 18, is an electronic device having a rectangular enclosure 630, containing the same electronic components as Embodiment 5 and supporting the on/off and volume knob 631 and an additional audio socket jack 645 in FIG. 18, fitting the audio plug 626 in FIG. 17. In Embodiment 6, the speaker is a flat powered speaker 650 in FIG. 18, having an internal battery and an on-off button 652 in FIG. 18, the speaker's case serving as cover of the rectangular enclosure 630.

FIGS. 20 and 21, show the location of the circuit board 632, the electronic circuit 633, the 9V battery 636, the battery connector 634, the output socket jack 644 and the input socket jack 643. The rectangular enclosure 630 in FIG. 18 provides for a hands-free operation, via a shoulder strap, or a belt clip, or a camera-type carrying bag having a shoulder strap, or other means.

Embodiment 6 provides a hands-free electronic kazoo musical instrument, the hands of a person playing the kazoo instrument being available for other activities including playing another hand-held instrument such as a guitar or a keyboard or drums. Embodiment 6, also provides a hands-free electronic kazoo musical instrument to disabled persons, who cannot use effectively their hands.

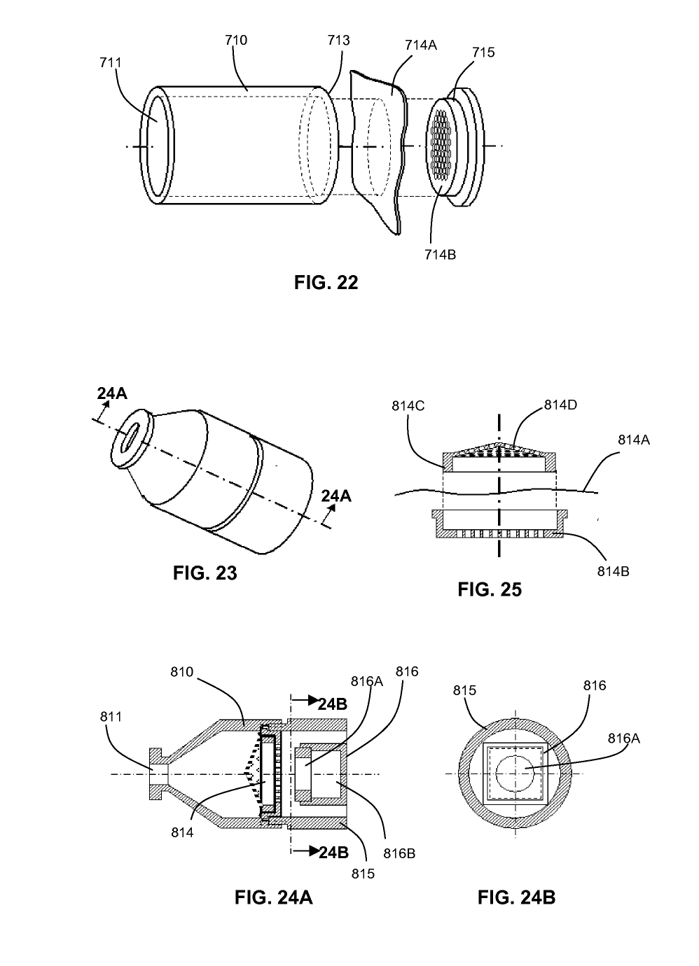

### FIGS. 22, 23, 24A, 24B and 25—Embodiments 7 and 8

It is understood that the kazoo devices and their components, including novel composite vibrating diaphragms, may have different design, or geometry, or materials used, or holding means, than those described, but still apply the principles, spirit and scope described in the claims of the present invention.

Embodiment 7 is an example of different kazoo device configuration, illustrated in FIG. 22. It comprises, a hollow cylinder 710 having two open ends, the first serving as humming inlet 711 and the second serving as sound outlet opening 713 having an internal diameter fitting a flanged cylindrical cap 715, the bottom of the cap forming the perforated disk 714B of the composite diaphragm. The film 714A of the composite diaphragm is inserted and clamped between the cylinder sound outlet opening 713 and the perforated disk 714B.

Embodiment 8, illustrated in FIG. 23, is an example of different configuration of a kazoo device including a Helmholtz resonator. As shown in more detail in FIG. 24A, the holder 815 has a cylindrical extension fitting tightly a tubular body of square cross section 816 in FIG. 24B, having one closed end, the other end being capped by a square plate having a central circular opening forming the port 816A of the Helmholtz resonator, the cavity of the resonator 816B in FIG. 24A being formed by the tubular body, its closed end and its cap.

In this example of kazoo device configuration, as shown in FIG. 25, the composite vibrating diaphragm includes a protective plastic screen 814D attached to the locking ring 814C.

A variety of other configurations can be made, according to the principles of the present invention, such as wireless audio connexion between the mouth-held kazoo device and the electronic device of Embodiment 6, integration of a kazoo device and electronic processing in a wireless microphone, combination of a mouth-held kazoo device and a mobile telephone integrating the electronic processing and other.

It is understood that the principle of sound transducer used to convert the kazoo device sound to audio signal, may be different than the microphone capsule included in the described electronic devices, such as piezoelectric or other.

It is also understood that more than one Helmholtz resonators serving as band-stop filters, may be included in an a kazoo device, having various designs, geometry, materials used and arrangements.

It is further understood that the electronic processing of the signal produced by the sound transducer, may include more than one band-stop filters, or equalisers and apply various desired audio effects, may use different components and may have different design, while the speaker, with or without mp3 player, may be part of the internal electronic system, instead of being a commercial off-the-shelf powered speaker. All features, including signal processing, internal mp3 player for background music, or audio connexions, wired or wireless, can be fully or partially combined in a kazoo and still apply the principles, spirit and scope described in the claims of the present invention.

The described audio devices may have different configuration, shape and materials used, different audio connexions with external audio devices and different utilization features, but still apply the principles, spirit and scope described in the claims of the present invention.

As other examples of variations, a kazoo device may have replaceable mouthpiece cover; the vibrating diaphragm may have a different shape than circular; the holes of the perforated disk may have a different shape than circular as well as different diameter and may represent a different total percentage of the area of the disk; instead of being peripherally clamped, the film may be glued across the surface of the perforated disk, or pressed between two perforated disks having fitting holes, the film may be made of different materials and may have different thickness, to the extend the combination of the film and the perforated disk, provides for formation of an individual vibrating membrane at each hole of the perforated disk having a fundamental resonance frequency in the mid audio, or the upper mid audio ranges.

Many other variations can be described, however the examples above, sufficiently demonstrate that a large field of different configurations is possible within the scope of the present invention. Therefore, it will be understood that the scope of the invention is not limited to the illustrated embodiments. Any alterations and further modifications in the described embodiments, and any further applications of the principles of the invention as described herein, are contemplated as would normally occur to one skilled in the art to which the invention relates.

### CONCLUSION, RAMIFICATIONS, AND SCOPE

From some of the embodiment descriptions above, a number of advantages become evident, related to:

a. new kazoo devices yielding a pleasing musical sound, which can be used by persons capable of humming a melody in tune, requiring only singing skills,

b. new electronic kazoo devices providing a controlled audio signal, free from buzzing content, to applications or devices using a kazoo device as an audio input,

c. new electronic kazoo musical instruments transforming a person's humming sound to a pleasing instrumental sound, acoustically perceived as a saxophone's, or other wind instrument's sound,

d. such musical instruments that are portable, compact and self-contained, easily transported while being played or not,

e. such musical instruments that are capable of being connected to earphones for practice, or to external amplified speakers, or audio consoles for live performance, with zero latency,

f. such musical instruments that can be played, while accompanying the played melody with music, or rhythm, from an internal or external audio source such as a mp3 player, a drum machine, a synthesizer, or other,

g. such musical instruments that are hands-free, capable of being played by a person accompanying the melody hummed by a hand-operated musical instrument, or of being played by physically handicapped persons, who cannot use effectively their hands.

h. such audio devices and musical instruments that can be manufactured at low cost.

Accordingly, the reader will see that the kazoo device concept and the method of transforming a person's humming to a pleasing musical sound provide for numerous new applications, in the fields of kazoo devices and kazoo musical instruments.

While the detailed descriptions of the illustrated embodiments contain specificities, these should not be construed as limitations on the scope, but as examples for explanation purposes. One of ordinary skill in the art will realize that the invention may be practiced without the use of these specific details.

Although the invention is described herein with reference to the discussed embodiments, one skilled in the art will readily appreciate that other applications may be substituted for those set forth herein without departing from the spirit and scope of the present invention. Accordingly, the invention should only be limited by the Claims included below.

What is claimed is:

1. A kazoo device comprising: a hollow body having an inlet opening serving for a person's humming and a sound outlet opening; a composite vibrating diaphragm, including a rigid perforated disk having a plurality of holes distributed across its surface and a thin plastic film stretched across the surface of said disk, being peripherally fixed to said perforated disk, said film obstructing said sound outlet opening and; a holding means configured to hold said diaphragm attached to said sound outlet opening, said diaphragm being configured to form an individual membrane fixed at the rim at each of said holes, whereby said individual membranes vibrate during operation at regular vibrating modes yielding a smoothened kazoo device's sound.

2. The kazoo device of claim 1, wherein said inlet opening has a tubular flanged extension, providing for being mouth-held, for a hands-free operation.

3. The kazoo device of claim 1, further comprising a filtering means configured to attenuate the amplitude of predetermined frequency bands, whereby any audible buzzing content of the kazoo device's sound, is filtered.

4. The kazoo device of claim 3, wherein said filtering means includes at least one Helmholtz resonator, serving as a band-stop filter.

5. The kazoo device of claim 2 further comprising a sound transducer configured to capture and convert the kazoo device's sound to audio signal, whereby the transducer's audio signal is serving as an audio input signal to other audio devices.

6. The kazoo device of claim 5 further including an electronic circuit configured to process said transducer's signal for adjusting the amplitude of predetermined frequency bands of the audio frequency range and applying predetermined audio effects, providing a processed signal serving as an audio input to other audio devices, or to earphones, whereby said processed signal has a predetermined timbre.

7. The kazoo device of claim 6, further comprising a speaker converting the processed signal to sound.

8. The kazoo device of claim 7, further comprising an electronic mixing means, providing for mixing said processed signal with an audio signal from an integrated or an external audio device, whereby said audio signal is serving to accompany the person's humming sound.

9. The kazoo device of claim 8, having all its components contained in a single compact hand-held housing, providing an electronic kazoo musical instrument transforming a person's humming to a pleasing instrumental sound.

10. The kazoo device of claim 8, having all its components contained in two separate parts interconnected via an audio cable, the first part being the mouth-held kazoo device of claim 5 including a sound transducer and the second part being a portable electronic device including all the other components of the kazoo device of claim 8, said two parts providing a hands-free electronic kazoo musical instrument transforming a person's humming to a pleasing instrumental sound.

11. The kazoo device of claim 10, wherein said first part further includes a compact wireless audio transmitter and said second part further includes a wireless audio receiver, providing for a wireless connection between said parts.

12. A method of transforming a person's humming to a pleasing musical sound comprising:
(a) providing a kazoo device including a composite vibrating diaphragm forming a plurality of individual membranes fixed at the rim, vibrating at regular vibrating modes and having predetermined fundamental resonance frequencies,
(b) converting said kazoo device's sound to audio signal,
(c) electronically processing said audio signal for adjusting the amplitude of predetermined frequency bands and applying desired audio effects,
(d) mixing said processed audio signal with another audio signal, serving to accompany the person's humming sound.
(e) converting said processed audio signal to output sound, whereby said sound has a predetermined timbre.
